(19) United States
(12) Patent Application Publication
(10) Pub. No.: US 2011/0024235 A1
(43) Pub. Date: Feb. 3, 2011

(54) SAWHORSE BRACKET SYSTEM AND METHOD

(75) Inventors: Michael Johnson, Waterville, WA (US); Phil Johnson, Waterville, WA (US)

Correspondence Address: GRAYBEAL JACKSON LLP, 400 - 108TH AVENUE NE, SUITE 700, BELLEVUE, WA, 98004, US

(73) Assignee: Johnson Air Service, Inc., Waterville, WA (US)

(21) Appl. No.: 12/843,590

(22) Filed: Jul. 26, 2010

Related U.S. Application Data
(60) Provisional application No. 61/281,984, filed on Nov. 27, 2009.
(60) Provisional application No. 61/273,211, filed on Jul. 31, 2009.

(51) Int. Cl. B25H 1/06; F16M 11/16; F16M 11/22; E04G 1/32

(52) U.S. Cl. 182/186.3; 248/188; 182/224

(57) ABSTRACT

Embodiments of sawhorse systems are shown and described, which may include one or more sawhorse-stand units. A sawhorse stand unit may comprise one or more top bracket, and one or more bottom bracket, which are coupled to vertical supports. Additionally, a horizontal member may extend between top brackets of the sawhorse-stand units. The horizontal and vertical supports may correspond, in size and shape, to dimensional lumber.

### PRIORITY CLAM

This application claims the benefit of U.S. Provisional Application No. 61/273,211 filed on Jul. 31, 2009, and U.S. Provisional Application No. 61/281,984 filed on Nov. 27, 2009 which are incorporated herein by reference in their entireties for all purposes.

### FIELD

This disclosure relates generally to work tools, and more specifically to sawhorse bracket systems and methods.

### BACKGROUND

Sawhorses are widely used throughout the world by skilled tradesmen and homeowners alike for a variety of reasons, tasks and basic needs. Traditional sawhorses are generally defined as a horizontal beam with four downwardly diverging angled supports referred to as sawhorse legs. Since its inception, the sawhorse has undergone few revolutionary design changes that have substantially improved its form and function. Molded plastic, collapsible or folding sawhorses, metal folding sawhorses, metal folding saw horses with adjustable legs for varying heights are just a few of the varieties available on the market today. Although each of the sawhorse versions listed above exhibit differences in designs not one of the versions deviate from the four downwardly diverging angled leg support concept which continues to dominate the sawhorse market today.

Traditional sawhorse designs and the variations which exist on the market today are deficient in various ways. For example, a consumer is limited or restricted by the manufacturer's predetermined dimensions which are often different than what is actually needed or preferred by the user to complete a particular task. Storing and transporting the sawhorse becomes an issue when space is at a premium. Traditional sawhorses cannot be easily disassembled and assembled, or in the case of plastic or metal constructed sawhorses, are not designed to be disassembled and therefore do not compact for easy storage or transport.

Plastic collapsible or folding sawhorses on the market today lack durability and strength. They are not suitable for heavy duty jobs (more than 1,000 lbs.) and are not easily repairable should a plastic component become damaged as a result of normal use.

Metal collapsible or folding sawhorses are heavy by design and lack extreme rigidity without providing the option of adapting a horizontal or diagonal cross brace which would aid in the restriction of any unwanted movement.

### BRIEF DESCRIPTION OF THE DRAWINGS

The present disclosure will be presented by way of exemplary embodiments but not limitations, illustrated in the accompanying drawings in which like references denote similar elements, and in which:

FIG. 1a depicts a pair of sawhorse-stand units in accordance with an embodiment.

FIG. 1b depicts a pair of sawhorse-stand units in accordance with another embodiment.

FIG. 1c depicts a pair of sawhorse-stand units in accordance with a further embodiment.

FIG. 2a depicts a pair of top brackets in accordance with an embodiment, which may be part of a sawhorse-stand unit as depicted in FIG. 1a.

FIG. 2b depicts a pair of bottom brackets in accordance with an embodiment, which may be part of a sawhorse-stand unit as depicted in FIG. 1a.

FIG. 2c depicts a pair of bottom brackets coupled to a vertical support in accordance with an embodiment, which may be part of a sawhorse-stand unit as depicted in FIG. 1a.

FIG. 2d depicts a pair of bottom brackets and a pair of top brackets coupled to a vertical support in accordance with an embodiment which may be part of a sawhorse-stand unit as depicted in FIG. 1a.

FIG. 3a depicts a top bracket in accordance with another embodiment, which may be part of a sawhorse-stand unit as depicted in FIG. 1b.

FIG. 3b depicts a bottom bracket in accordance with an embodiment, which may be part of a sawhorse-stand unit as depicted in FIG. 1b.

FIG. 3c depicts a bottom bracket and a top bracket coupled to a vertical support in accordance with an embodiment, which may be a sawhorse-stand unit as depicted in FIG. 1b.

FIG. 3d depicts a see-through view of a top bracket in accordance with an embodiment, which may be part of a sawhorse-stand unit as depicted in FIG. 1b.

FIGS. 3e and 3f depict a bottom-bracket-pressure member in accordance with an embodiment, which may be part of a sawhorse-stand unit as depicted in FIG. 1b.

FIG. 4a depicts a top-vertical-support-coupling member in accordance with an embodiment, which may be part of a sawhorse-stand unit as depicted in FIG. 1c.

FIG. 4b depicts a top bracket in accordance with an embodiment, which may be part of a sawhorse-stand unit as depicted in FIG. 1c.

FIG. 4c depicts a bottom bracket in accordance with an embodiment, which may be part of a sawhorse-stand unit as depicted in FIG. 1c.

FIG. 4d depicts a top bracket and a bottom bracket coupled with a vertical support and a top support in accordance with an embodiment, which may be part of a sawhorse-stand unit as depicted in FIG. 1c.

FIG. 5a depicts a link bracket in accordance with an embodiment.

FIG. 5b depicts a link bracket coupled to a vertical support and a cross-brace in accordance with an embodiment.

### DESCRIPTION

Illustrative embodiments presented herein include, but are not limited to, sawhorse bracket systems and methods. Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order to not obscure the illustrative embodiments.

Additionally, it should be clear that the embodiments described herein are merely examples, and that any element or component of a described embodiment, may be present in various other embodiments. Moreover, various components or parts described herein may be interchangeable between embodiments.

Embodiments of sawhorse systems 100A, 110B, 1100 are depicted, which include a pair of sawhorse-stand units 105A₁, 105A₂, 105B₁, 105B₂, 105C₁, 105C₂, The sawhorses systems 100A, 100B, 1000 comprise top brackets 110A₁, 110A₂, 110A₃, 110A₄, 110B₁, 110B₂, 110C₁, 110C₂ and bottom brackets 120A₁, 120A₂, 120A₃, 120A₄, 120B₁, 120B₂, 120C₁, 120C₂ which are coupled to vertical supports 125A₁, 125A₂, 125B₁, 125B₂, 125C₁, 125C₂. Additionally, a horizontal member 115A 115B, 115C may extend between top brackets 110A₁, 110A₂, 110A₃, 110A₄, 110B₁, 110B₂, 110C₁, 110C₂ of the sawhorse-stand units 105A₁, 105A₂, 105B₁, 105B₂, 105C₁, 105C₂.

For example, in some embodiments, a vertical support 125A₁, 125A₂, 125B₁, 125B₂, 125C₁, 125C₂ may be made from dimensional lumber, or the like, which may be desirable because sawhorse-stand units 105A₁, 105A₂, 105B₁, 105B₂, 105C₁, 105C₂ may be made any desirable height based on requirements of a user, and sawhorse-stand units 105A₁, 105A₂, 105B₁, 105B₂, 105C₁, 105C₂ may be easily modified and re-built to accommodate different needs. Moreover, sawhorse-stand units 105A₁, 105A₂, 105B₁, 105B₂, 105C₁, 105C₂ may be easily disassembled for transport, or the like.

Additionally, a horizontal member 115A 115B, 115C may be coupled with one or more sawhorse-stand units 105A₁, 105A₂, 105B₁, 105B₂, 105C₁, 105C₂, and the horizontal member 115A 115B, 115C may be used as a work surface, or the like. Alternatively, the horizontal member 115A 115B, 115C may itself be a work piece.

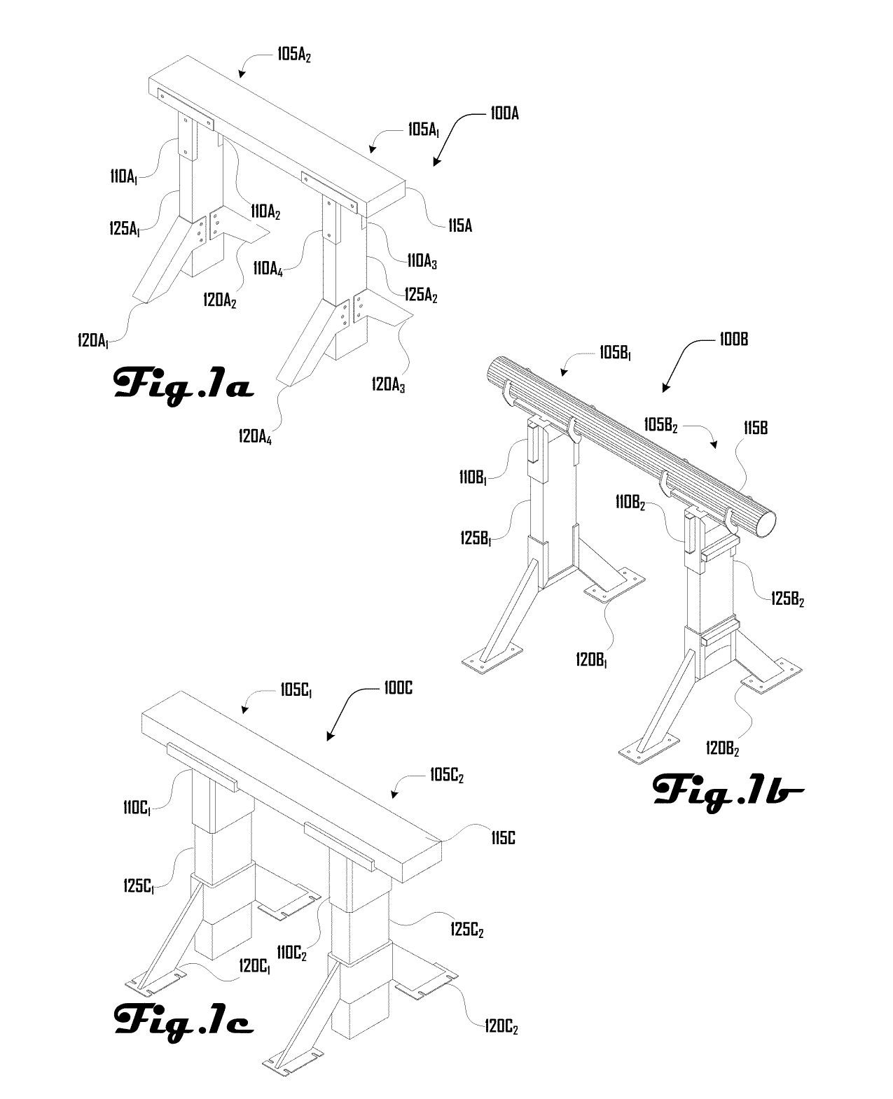

Referring to FIG. 1a, in an embodiment, a sawhorse system 100A comprises a first and second vertical support 125A₁, 125A₂. First and second bottom brackets 120A₁, 120A₂ and 120A₃, 120A₄ are coupled to opposing sides of a bottom end of each vertical support 125A₁, 125A₂, and the bottom end of the vertical support 125A₁, 125A₂ extends parallel to the bottom of each bottom bracket 120A₁, 120A₂, 120A₃, 120A₄. Additionally, first and second top brackets 110A₁, 110A₂ and 110A₃, 110A₄ are coupled to opposing sides of a top end of each vertical support 125A₁, 125A₂. Each set of vertical supports 125A₁, 125A₂, and bottom and top brackets 110A₁, 110A₂ and 110A₃, 110A₄, 120A and 120A₁, 120A₂, 120A₃, 120A₄ is collectively a sawhorse-stand unit 105A₁, 105A₂ and the sawhorse-stand units 105A₁, 105A₂ may be coupled via a horizontal support 115A, 115B, 115C, which is coupled to each sawhorse-stand unit 105A₁, 105A₂ via respective top brackets 110A₁, 110A₂ and 110A₃, 110A₄.

Referring to FIG. 1b, in an embodiment, a sawhorse system 100B comprises a first and second sawhorse-stand unit 105B₁, 105B₂. Each sawhorse stand unit 105B₁, 105B₂ comprises a vertical support 125B₁, 125B₂, a top bracket 110B₁, 110B₂ coupled to a top end of the vertical support 125B₁, 125B₂, and a bottom bracket 120B₁, 120B₂ coupled to a bottom end of the vertical support 125B₁, 125B₂. The top bracket 110B₁, 110B₂ of each sawhorse stand unit 105B₁, 105B₂ may couple with a horizontal support 115B.

Referring to FIG. 1c, in an embodiment, a sawhorse system 1000 comprises a first and second sawhorse-stand unit 105C₁, 105C₂. Each sawhorse stand unit 105C₁, 105C₂ comprises a vertical support 125C₁, 125C₂, a top bracket 110C₁, 110C₂ coupled to a top end of the vertical support 125C₁, 125C₂, and a bottom bracket 120C₁, 120C₂ coupled to a bottom end of the vertical support 125C₁, 125C₂. The bottom end of the vertical support 125C₁, 125C₂ may extend through the bottom bracket and be parallel to the bottom of the feet of the bottom bracket 120C₁, 120C₂. The top bracket 110C₁, 110C₂ of each sawhorse stand unit 1105C₁, 105C₂ may couple with a horizontal support 115C.

In various embodiments, a vertical support 125A₁, 125A₂, 125B₁, 125B₂, 125C₁, 125C₂ or horizontal support 115A, 115B, 115C may comprise dimensional lumber of various sizes (e.g. 2×2, 2×4, 4×4, 4×6, 4×8 and the like), and components of a sawhorse system 100A, 100B, 1000 may be sized to accommodate varying dimensional lumber sizes. However, in further embodiments, a vertical support 125A₁, 125A₂, 125B₁, 125B₂, 125C₁, 125C₂ or horizontal support 115A, 115B, 115C may comprise lumber or other materials of any suitable size. For example, as depicted in FIG. 1b, a horizontal support 115B may be cylindrical. In various embodiments, the horizontal support 115A, 115B, 115C need not provide support, and may instead be itself supported by one or more sawhorse stand unit 105A₁, 105A₂, 105B₁, 105B₂, 105C₁, 105C₂.

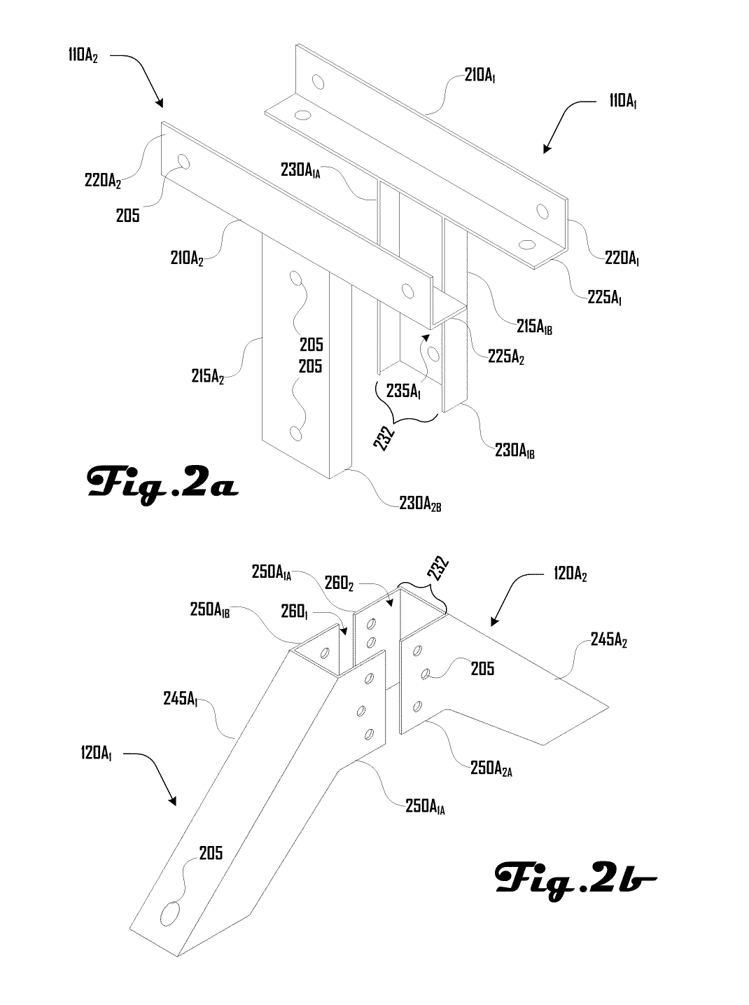

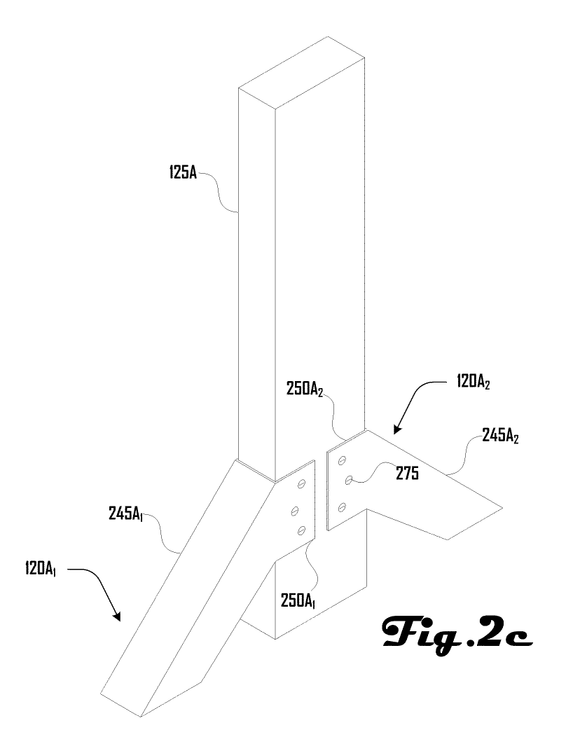

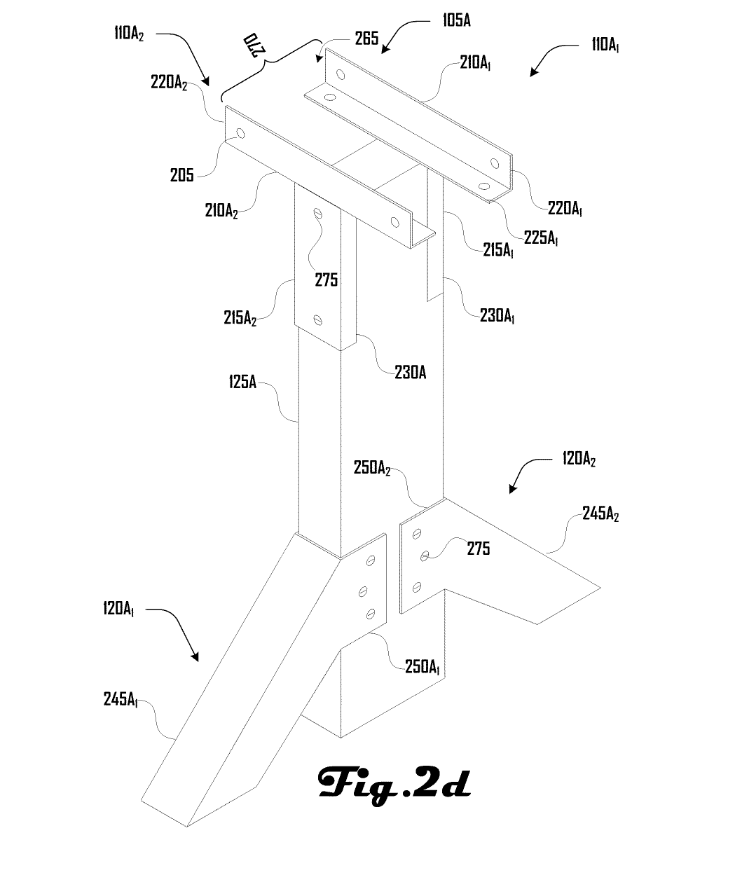

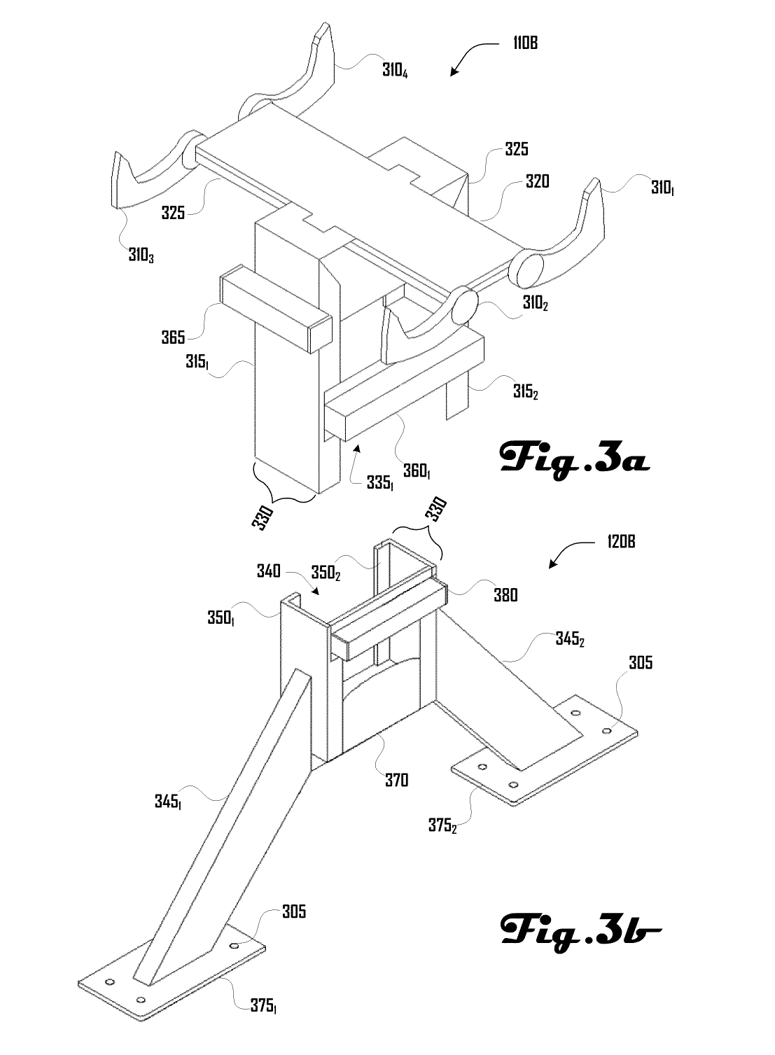

FIGS. 2a, 2b, 2c and 2d depict one embodiment of a sawhorse-stand unit 105A. Referring to FIG. 2a, a first and second top brackets 110A₁, 110A₂ are depicted. Each top bracket 110A₁, 110A₂ comprises a vertical retaining-edge member 220A₁, 220A₂ and a horizontal retaining-edge member 225A₁, 225A₂ which are elongated planar members that are coupled along an edge. As depicted in FIG. 2a, the vertical and horizontal retaining-edge members 220A₁, 220A₂, 225A₁, 225A₂ may substantially form a 90° angle to each other or be substantially perpendicular.

Each top bracket 110A₁, 110A₂ further comprises a vertical-top-coupling slot 235A, which is defined by a first and second top-coupling flange 230A_{1A}, 230A_{1B} 230A_{2b} and a top-coupling back 215A₁, 215A₂. The first and second top-coupling flange 230A_{1A}, 230A_{1B} 230A_{2b} may be substantially parallel and perpendicular to the top-coupling back 215A₁, 215A₂ and each top-coupling flange 230A_{1A}, 230A_{1B} 230A_{2b} may substantially form a 90° angle to the top-coupling back 215A₁, 215A₂ or be substantially perpendicular to the top-coupling back 215A₁, 215A₂. Additionally, the vertical-top-coupling slot 235A₁ may be further defined by a portion of the horizontal retaining-edge member 225A₁, 225A₂. In various embodiments, the width 232 of the vertical-top-coupling slot 235A₁ may correspond to a size of dimensional lumber.

Each top bracket 110A₁, 110A₂ may further comprise a plurality of coupling holes 205. An exemplary depiction of coupling hole positioning is depicted in FIGS. 2a, 2b, 2c and 2d; however, it should be clear that in some embodiments coupling holes 205 may be positioned in any suitable location or may be absent as desired. Coupling holes 205 (or fastener holes) may be an orifice of suitable size which allows various types of fasteners to extend therethrough (e.g. screws, nails, or the like)

Referring now to FIG. 2b, a first and second bottom bracket 120A₁, 120A₂ are depicted. Each bottom bracket 120A₁, 120A₂ comprises a leg extension 245A₁, 245A₂ and a first and second leg-coupling flange 250A_{1A}, 250A_{1B}, 250A_{2A}, 250A_{2B}. Coupling holes 205 may also be present on the leg extension 245A₁, 245A₂ and first and second leg-coupling flange 250A_{1A}, 250A_{1B}, 250A_{2A}, 250A_{2B}. The first and second leg-coupling flange 250A_{1A}, 250A_{1B}, 250A_{2A}, 250A_{2B} may define a leg-coupling slot 260₁, 260₂ which may have a width 232 that corresponds to dimensional lumber.

As depicted in FIGS. 2c and 2d, the first and second bottom bracket 120A₁, 120A₂ may be coupled to a bottom end of a vertical support 125A via screws 275 that extend through coupling holes 205 and into the vertical support. As shown in FIGS. 1a, 2c and 2d, the vertical support 125A may extend through the bottom bracket slot 260A and the bottom end of the vertical support 125A may be parallel to the bottoms of the first and second bottom bracket 120A₁, 120A₂. This may be desirable in some embodiments because the bottom of the vertical support 125A may engage the ground along with the base of the first and second bottom bracket 120A₁, 120A₂ and thereby provide further stability to the sawhorse stand unit 105A.

Referring to FIG. 2d, the top brackets 110A₁, 110A₂ may be coupled to a top end of the vertical support 125A via fasteners 275 (e.g. screws) that extend through coupling holes 205. When coupled to the vertical support 125A the first and second top brackets 110A₁, 110A₂ may define horizontal-support-coupling slot 265, in which a horizontal support 115A (FIG. 1a) may reside or be coupled. The width 270 of the horizontal-support-coupling slot 265 may correspond to dimensional lumber.

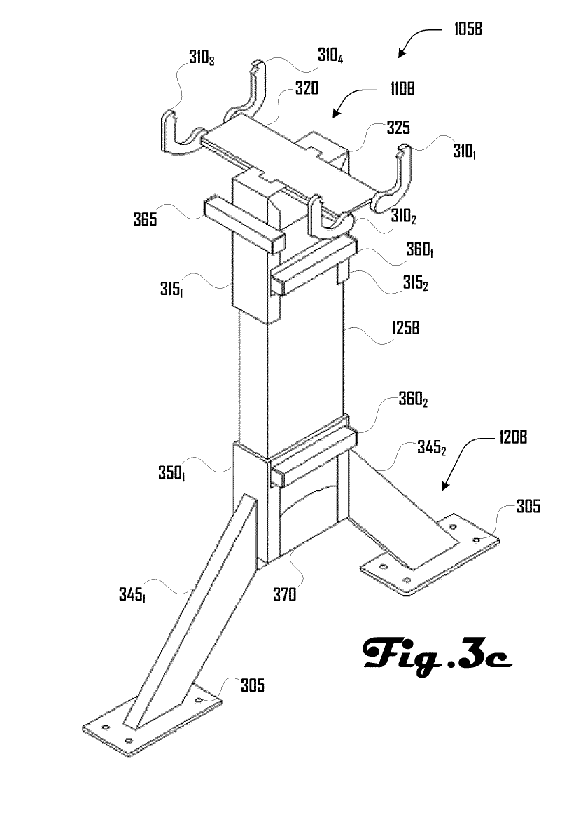

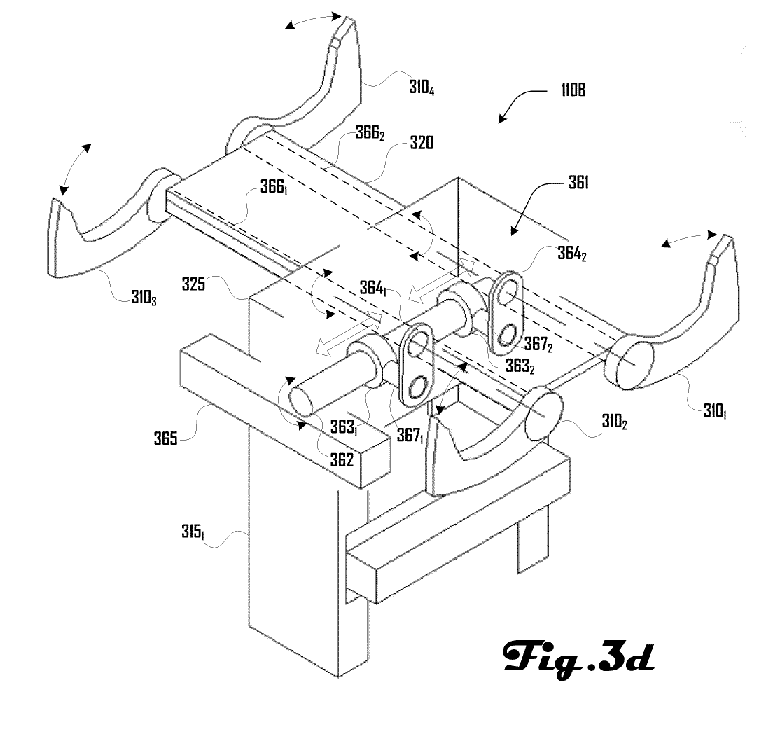

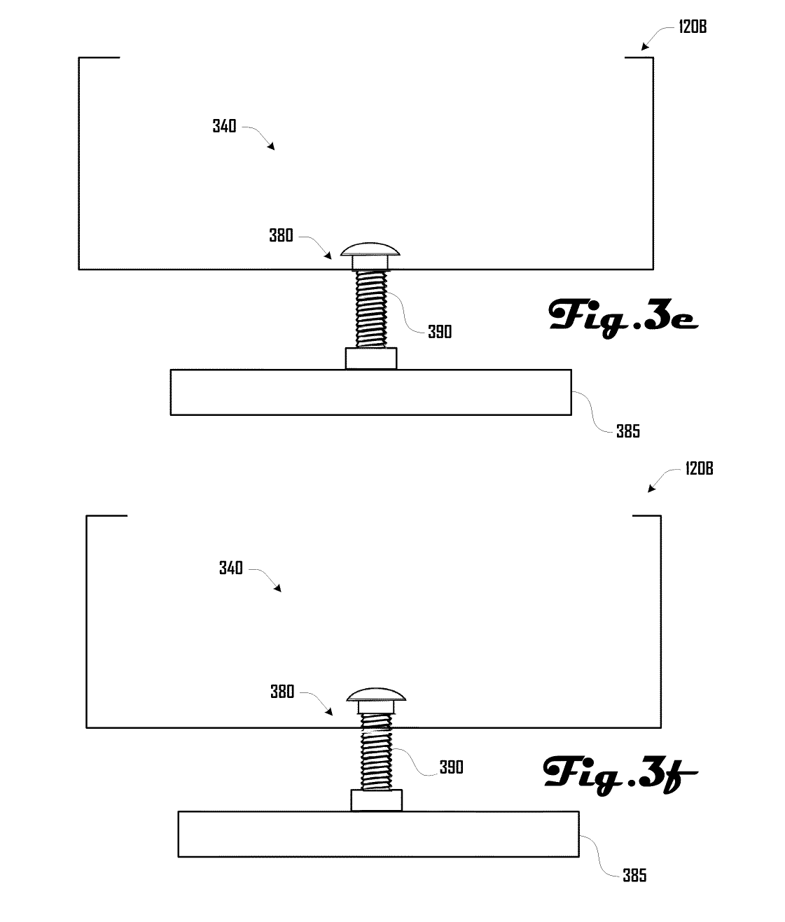

FIGS. 3a, 3b, 3c and 3d depict one embodiment of a sawhorse-stand unit 105B. FIG. 3a depicts a top bracket comprising a bracket head 325, and a first and second top-sidewall 315₁, 315₂ descending from the bracket head 325. A top-bracket slot 335 is defined by the bracket head 325 and the first and second top-sidewalls 315₁, 315₂. In various embodiments, the top-bracket slot 335 corresponds to an end of dimensional lumber. Located on top of the bracket head 325 and extending therefrom is a bracket plate 320. The bracket plate may be substantially planar and rectangular, and may comprise a first, second, third and fourth grasping arms 310₁, 310₂, 310₃, 310₄.

Pairs of grasping arms 310₁, 310₂ and 310₃, 310₄ are located on opposing ends of the bracket plate 320. As further described herein, the each grasping arm 310₁, 310₂, 310₃, 310₄ in a pair is operable to rotate toward each other and thereby grasp objects. For example, grasping arm 310₁ is operable to rotate toward grasping arm 310₂ and vice versa. As further shown in FIGS. 3c and 3d described herein, the rotation of grasping arms 310₁, 310₂, 310₃, 310₄ is controlled by a grasping-actuator member 365, which may be a rotatable bar member.

The top bracket 110B further comprises a top-bracket-pressure member 360, which is operable to secure a vertical support 125B, which may reside within the top-bracket slot 335. The top-bracket-pressure member 360 is further described herein.

Referring to FIG. 3b a bottom bracket 120B is depicted, which comprises a bottom bracket base 370 and a first and second bottom-sidewalls 350₁, 350₂ extending from the bottom bracket base 370. The bottom bracket base 370 and first and second bottom-sidewalls 350₁, 350₂ define a bottom bracket slot 340, which may correspond to dimensional lumber in some embodiments.

Extending from the first and second bottom-sidewalls 350₁, 350₂, respectively, is a first and second leg extension 345₁, 345₂. At the bottom of each leg extension 345₁, 345₂ is a foot 375₁, 375₂, which may comprise a plurality of coupling holes 305. In some embodiments, coupling holes 305 or the feet 375₁, 375₂ may be absent. In some embodiments, fasteners may be used to couple the feet 375₁, 375₂ to a substrate such as the ground or to a base, such as dimensional lumber or the like.

The bottom bracket 120B further comprises a bottom-bracket-pressure member 380, which is operable to secure a vertical support 125B, which may reside within the bottom-bracket slot 340. The bottom-bracket-pressure member 380 is further shown in FIGS. 3e and 3f, and described below.

FIG. 3c depicts a sawhorse-stand unit 105B comprising a top bracket 110B and a bottom bracket 120B, which are coupled to a vertical support 125B. A top end of the vertical support 125B resides within the top-bracket slot 340 (FIG. 3a), and a bottom end of the vertical support 125B resides within the bottom-bracket slot 340.

FIG. 3d depicts a see-through view of a top bracket 110B, which illustrates a grasping-arm-actuation mechanism 361 in accordance with an embodiment. The grasping-arm-actuation mechanism 361 comprises a grasping-actuator member 365 that is coupled to an end of an actuation shaft 362, which has a first and second toggle 363 mounted thereon. For each toggle 363₁, 363₂ a pin 367₁, 367₂ is rotatably coupled to a clip 364₁, 364₂, and each clip 364₁, 364₂ is coupled to a respective grasping-arm rod 366₁, 366₂.

In one embodiment, the actuation shaft 362 is a dual threaded rod, wherein half of the rod is right-hand threaded and the other half is left-hand threaded (not shown). In such an embodiment, the toggles 363₁, 363₂ mounted on the actuation shaft 362 are threaded in the same handedness. In another embodiment, the actuation shaft 362 may be consistently threaded, and the toggles 363₁, 363₂ may have opposing thread handedness.

Accordingly, in either embodiment, when the grasping-actuator member 365 is rotated, the actuation shaft 362 also rotates. When the actuation shaft 362 rotates, the toggles 363₁, 363₂ move toward each other or away from each other along the actuation shaft 362 (depending on the direction that the actuation shaft 362 is rotating). As the toggles 363₁, 363₂ move along the actuation shaft 362, the clip 364₁, 364₂ causes each respective grasping-arm rod 366₁, 366₂ to rotate. The grasping-arm rods 366₁, 366₂ therefore rotate in opposite directions, which cause pairs of grasping arms 310₁, 310₂, and 310₃, 310₄ on each end of the bracket plate 320 to rotate towards each other or away from each other. Therefore, when the grasping-actuator member 365 is rotated, the pairs of grasping arms 310₁, 310₂, 310₃, 310₄ on each end of the bracket plate 320 rotate towards each other or away from each other depending on the direction that the grasping-actuator member 365 is rotated.

Although one embodiment of a grasping-arm-actuation mechanism 361 is depicted in FIG. 3d, various other embodiments are contemplated and within the scope of the present disclosure. For example, grasping arms 310₁, 310₂, 310₃, 310₄ may be spring loaded, or any other suitable mechanism that facilitates opening and closing the grasping arms 310₁, 310₂, 310₃, 310₄ may be used. Additionally, the grasping arms 310 depicted herein are only an example of one embodiment of a grasping arm 310₁, 310₂, 310₃, 310₄. Any suitable shape or design may be used for a grasping arm 310₁, 310₂, 310₃, 310₄ in various embodiments.

FIGS. 3e and 3f depict a bottom-bracket-pressure member 380 in accordance with an embodiment. However the bottom-bracket-pressure member 380 depicted in these figures may be substantially analogous to a top-bracket-pressure member 360, and the like, in accordance with an embodiment. In FIGS. 3e and 3f, the bottom-bracket-pressure member 380 comprises a pressure actuator 385 and a bolt 390. The bolt is threaded, and extends through a complementary hole in the bottom bracket 120B, which allows the bolt 390 to extend into the bottom-bracket slot 340 when the pressure actuator 385 is rotated.

For example, when the pressure actuator 385 is rotated, the bolt 390 will extend further into the bottom-bracket slot 340 or may recede from the bottom-bracket slot 340. Therefore, when an object is present within the bottom-bracket slot 340 (e.g. a vertical support member 125B), pressure may be applied by rotating the pressure actuator 385 such that the bolt 390 extends into the bottom-bracket slot 340 and contacts the object residing therein. For example, the bolt 390 may be urged against a vertical support member 125B within the bottom-bracket slot 340 to a fix vertical support member 125 therein.

Although FIGS. 3e and 3f depict and an exemplary bottom-bracket-pressure member 380, in other embodiments, the bolt 390 or pressure actuator 385 may be configured in any suitable way. For example, the bolt may have a different head, or lack a head, or the pressure actuator may be a wheel or other suitable actuator member.

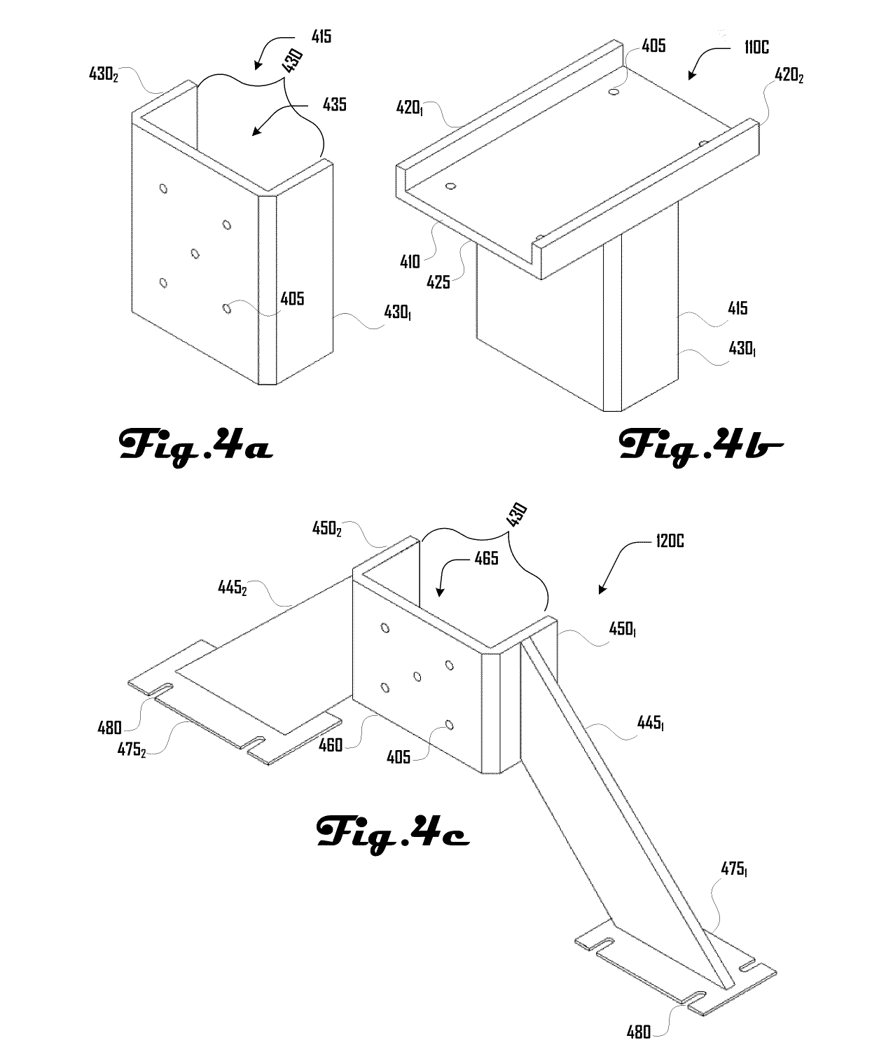

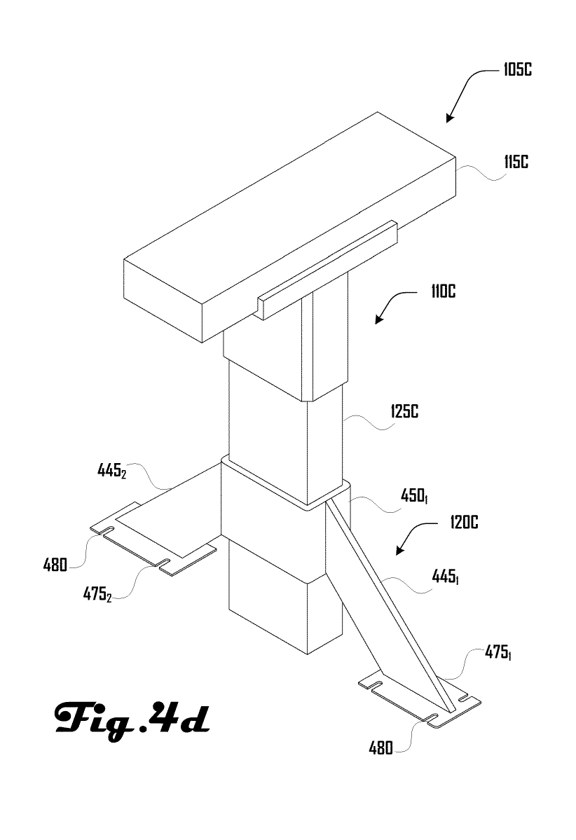

FIGS. 4a, 4b, 4c and 4d depict a sawhorse-stand unit 105C and components thereof in accordance with an embodiment. FIG. 4a depicts a portion of a top bracket 110C, which includes a vertical top coupling slot 435 defined by a first and second top coupling flange 430₁, 430₂, and a top-coupling-back member 415. The first and second top coupling flange 430₁, 430₂ may extend perpendicularly from opposing ends of the top-coupling-back member 415. In some embodiments, coupling holes 405 may be present on the top-coupling-back member 415 or a top coupling flange 430₁, 430₂.

FIG. 4b depicts the top bracket 110C which includes a top-coupling-back member 415 and a first and second top coupling flange 430₁, 430₂. Additionally, the top bracket 110C includes a top-coupling tray 410 having a first and second top-coupling-tray flange 420₁, 420₂. The top-coupling tray 410 defines a horizontal top-coupling slot 425. Additionally, there may be one or more coupling holes 405 thereon.

As depicted in FIG. 4b, the top-coupling tray 410 is coupled to an end of the first and second top coupling flange 430₁, 430₂ and top-coupling-back member 415. In various embodiments the top-coupling tray 410 may be substantially perpendicular to and centered over the first and second top coupling flange 430 and top-coupling-back member 415.

FIG. 4c depicts a bottom bracket 120C, which includes a first and second bottom-coupling flange 450₁, 450₂ which extend perpendicularly from a bottom-coupling-back member 460 to define a vertical bottom-coupling slot 465. Additionally, a first and second leg extension 445₁, 445₂ extend from the first and second flange 450₁, 450₂ respectively. A first and second foot 475₁, 475₂ are positioned and the end of each leg extension 445₁, 445₂.

In some embodiments, the foot may comprise one or more fastener slot 480, or the like. The top-coupling-back member 415 may comprise one or more coupling holes 405, or the like. Fastener slots 480 may be used to couple the bottom bracket 120C to a substrate or other object.

FIG. 4d depicts a bottom bracket 120C and a top bracket 110C coupled to a vertical support 125C and a horizontal support 115C. In some embodiments, the vertical and horizontal supports 125C, 115C may be coupled via fasteners through coupling holes (not shown), may be coupled via friction fit, or the like. In some embodiments, the vertical bottom-coupling slot 465 or the vertical top-coupling slot 435, may be defined by three sides as depicted in FIGS. 4a, 4b and 4c. However, in some embodiments, the vertical bottom-coupling slot 465 or the vertical top-coupling slot 435 may be defined by four sides. Additionally, any of the vertical bottom-coupling slot 465, the vertical top-coupling slot 435, or the horizontal top-coupling slot 425 may correspond to any suitable size of dimensional lumber.

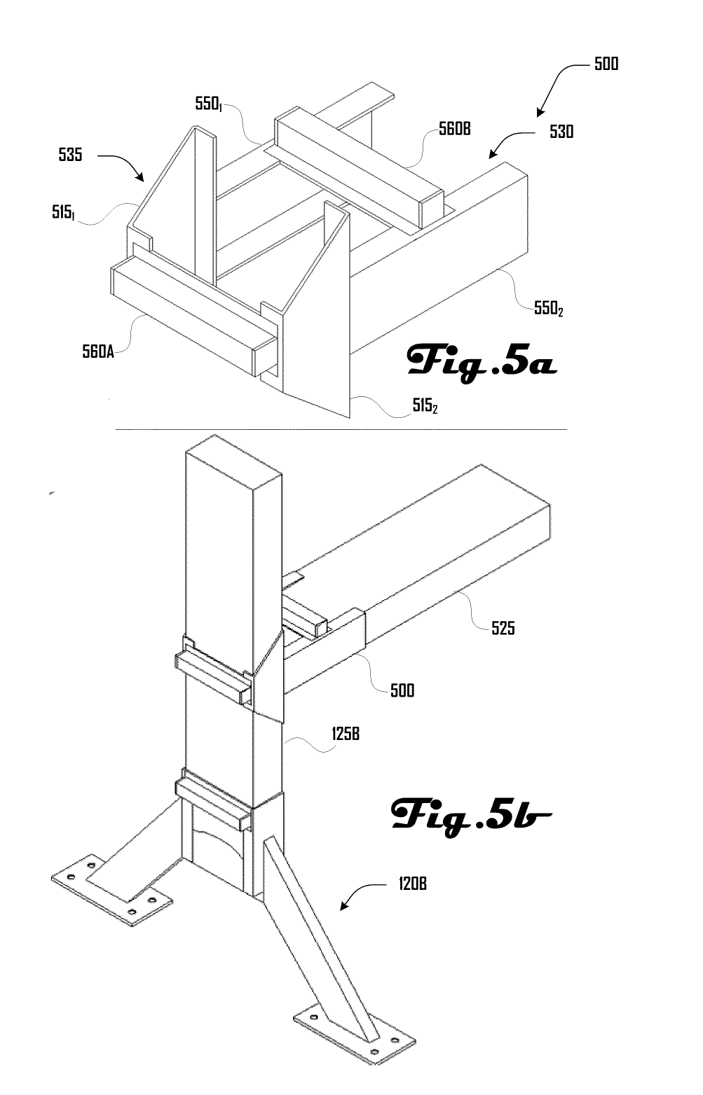

FIGS. 5a and 5b depict a link bracket 500 in accordance with an embodiment. The link bracket 500 may be used to provide support between or couple pairs of sawhorse-stand units 105 (e.g. FIG. 1) by coupling respective vertical supports 125 of the sawhorse-stand units 105. Such a configuration may be desirable to limit movement of sawhorse-stand units 105 supporting a work piece or horizontal support 115.

The link bracket 500 comprises a vertical coupling slot 535 and a horizontal coupling slot 530. The vertical coupling slot 535 is configured to couple with a vertical support 125B, and the horizontal coupling slot 530 is configured to couple with a first end of a cross-brace 525. A second end of the cross brace 525 may couple with a second link bracket 500 that may be coupled to another sawhorse-stand unit 105 (not shown).

The vertical coupling slot 535 is defined by a first and second vertical-sidewall member 515 and the horizontal coupling slot 530 is defined by a first and second horizontal sidewall member 550.

A pressure member 560A may be coupled to the first and second vertical-sidewall member 515, and may facilitate coupling of a vertical support member 125 within the vertical coupling slot 535. A pressure member 560B may also be coupled to the first and second horizontal sidewall member 550 and may facilitate coupling of a cross-brace within the horizontal coupling slot 530. Pressure members depicted in FIGS. 5a and 5b may be analogous to the bottom-bracket-pressure member 380 as depicted in FIGS. 3e and 3f and described in association therewith.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes can be made without departing from the spirit and scope of the embodiments described herein.

1. A sawhorse bracket system comprising:
a top bracket comprising;
a bracket head;
a first and second top-sidewall, each descending from the bracket head;
a top-bracket slot defined by the bracket head and first and second top-sidewalls, the top-bracket slot corresponding to an end of dimensional lumber; and
a bracket plate coupled about the bracket head and comprising a first and second grasping arm each rotatably coupled to a first end of the bracket plate and operable to rotate toward and away from each other.

2. The sawhorse bracket system of claim 1, further comprising a third and fourth grasping arm each rotatably coupled to a second end of the bracket plate and operable to rotate toward and away from each other.

3. The sawhorse bracket system of claim 2,
wherein the bracket plate is substantially planar and rectangular;
wherein the first and second grasping arm are coupled about a first and second corner of the first end; and
wherein the third and fourth grasping arm are coupled about a third and fourth corner of the second end.

4. The sawhorse bracket system of claim 2,
wherein the first and third grasping arm are coupled via a first grasping rod and operable to substantially rotate in unison; and
wherein the second and fourth grasping arm are coupled via a second grasping rod and operable to substantially rotate in unison.

5. The sawhorse bracket system of claim 1, wherein the first and second grasping arm are actuated via a grasping-actuator member.

6. The sawhorse bracket system of claim 1, wherein the top bracket further comprises a top-bracket-pressure member operable to extend into the top-bracket slot.

7. The sawhorse bracket system of claim 1, further comprising:
a bottom bracket comprising:
a bottom-bracket base;
a first and second bottom-sidewall extending from the bottom-bracket base;
a bottom-bracket slot defined by the first and second bottom-sidewalls corresponding to an end of dimensional lumber and a bottom end of the first vertical support residing therein; and
a first and second leg extension respectively coupled to the first and second bottom-sidewall and extending away from the first vertical support in the same plane.

8. The sawhorse bracket system of claim 7, wherein the first and second leg extension comprise a first and second foot plate respectively.

9. The sawhorse bracket system of claim 7, wherein the bottom bracket further comprises a bottom-bracket-pressure member operable to extend into the bottom-bracket slot.

10. A sawhorse system comprising:
a first sawhorse stand unit comprising:
a first vertical support corresponding to dimensional lumber;
a first and second bottom bracket each comprising:
a leg extension;
a leg-coupling slot corresponding to dimensional lumber and defined by a first and second leg-coupling flange and a portion of the leg extension; and
at least one leg-fastener hole positioned on the first and second coupling flange,
wherein the first and second bottom brackets are respectively coupled to opposing sides of a first end of the vertical support and via at least one fastener through the at least one leg-fastener hole and the vertical support residing with the leg-coupling slots; and
a first and second top bracket each comprising:
a retaining rim comprising:
an elongated vertical retaining-edge member; and
an elongated horizontal retaining-edge member substantially perpendicularly coupled with the vertical retaining-edge member along an edge; and
at least one retaining-rim-fastener hole; and
a vertical-top-coupling slot corresponding to dimensional lumber and defined by:
a first and second top-coupling flange coupled perpendicularly to the retaining rim and;
a top-coupling back coupled perpendicularly to the retaining rim and, and
a portion of the retaining rim; and
at least one top-coupling-slot-fastener hole,
wherein the first and second top bracket are coupled to a top-terminal end of the vertical support such that at least the first and second retaining rim define a horizontal-top-coupling slot corresponding to dimensional lumber.

11. The sawhorse of claim 10, further comprising a horizontal support comprising dimensional lumber, the horizontal support coupled within the vertical-top-coupling slot.

12. The sawhorse of claim 10, wherein an end of the vertical support extends through the leg-coupling slot and the bottom of the end resides in the same plane as a first and second foot base of the first and second bottom bracket respectively.

13. The sawhorse system of claim 10, further comprising a second sawhorse stand unit, the second sawhorse stand unit being substantially identical to the first sawhorse stand unit.

14. The sawhorse system of claim 13 comprising a horizontal support comprising dimensional lumber, the horizontal support coupled within the vertical-top-coupling slot of the first sawhorse-stand unit, and a second vertical-top-coupling slot of the second sawhorse-stand unit.

15. A sawhorse system comprising:
a first sawhorse-stand unit comprising:
a first vertical support comprising dimensional lumber;
a top bracket comprising:
a top-coupling-back member;
a first and second top-coupling flange extending perpendicularly from and coupled to opposing ends of the top-coupling-back member;
a vertical top-coupling slot defined by the top coupling back and the first and second top-coupling flange corresponding to dimensional lumber;
a top-coupling tray coupled perpendicularly to an end of the first and second top-coupling flange and comprising a first and second top-coupling-tray flange on respective opposing ends of the top-coupling tray;
a horizontal top-coupling slot defined by the top coupling tray; and
a plurality of top-fastening holes, with at least one defined by the top-coupling tray and one of a top-coupling flange and the top-coupling back member,
wherein a first terminal end of the first vertical support resides with the vertical top-coupling slot and is coupled therein via a fastener through at least one of the plurality of top-fastening holes; and
a bottom bracket comprising:
a bottom-coupling-back member;
a first and second bottom-coupling flange extending perpendicularly from and coupled to opposing ends of the top-coupling-back member;
a vertical bottom-coupling slot defined by the bottom-coupling back and the first and second bottom-coupling flange and corresponding to dimensional lumber;
at least one bottom-fastening hole defined by the bottom-coupling back member, wherein a second terminal end of the first vertical support resides with the vertical bottom-coupling slot and is coupled therein via a fastener through the least one bottom-fastening hole; and
a first and second leg extension respectively coupled to the first and second bottom-coupling flange and extending away from the first vertical support in the same plane.

16. The sawhorse of claim 10, further comprising a horizontal support comprising dimensional lumber, the horizontal support coupled within the top-coupling tray.

17. The sawhorse of claim 10, wherein an end of the vertical support extends through the vertical bottom-coupling slot and the bottom of the end resides in the same plane as a first and second foot base of the first and second bottom bracket respectively.

18. The sawhorse system of claim 10, further comprising a second sawhorse stand unit, the second sawhorse stand unit being substantially identical to the first sawhorse stand unit.

19. The sawhorse system of claim 13 comprising a horizontal support comprising dimensional lumber, the horizontal support coupled within the top-coupling tray of the first sawhorse-stand unit, and a second top-coupling tray of the second sawhorse-stand unit.
